(19) United States
(12) Patent Application Publication
(10) Pub. No.: US 2019/0033875 A1
(43) Pub. Date: Jan. 31, 2019

(54) OCCUPANCY-BASED VEHICLE COLLISION MANAGEMENT

(71) Applicant: Ford Global Technologies, LLC, Dearborn, MI (US)

(72) Inventors: Oswaldo Perez Barrera, Texcoco (MX); Victor Ariel Perez, Benito Juarez (MX); Alvaro Jimenez Hernandez, Miguel Hidalgo (MX)

(73) Assignee: Ford Global Technologies, LLC, Dearborn, MI (US)

(21) Appl. No.: 15/664,374

(22) Filed: Jul. 31, 2017

(51) Int. Cl. G05D 1/02; G05D 1/00; G08G 1/01; G08G 1/056; G08G 1/0968; G08G 1/052

(52) U.S. Cl. CPC G05D 1/0214; G05D 1/0088; G08G 1/052; G08G 1/056; G08G 1/096827; G08G 1/0112

(57) ABSTRACT

A map is generated identifying one or more surrounding vehicles including respective occupancy statuses for each surrounding vehicle. A host vehicle collision event is predicted. Based on the predicted collision event and the occupancy statuses, a host vehicle component is actuated.

### BACKGROUND

Autonomous or so-called self-driving vehicles do not require a human operator to navigate or move along roadways. Therefore, an autonomous vehicle can be occupied or unoccupied by a human occupant. Such vehicles can suffer from failures in vehicle subsystems, such as brakes, just as can conventional non-autonomous vehicles. Such failures can result in potential and/or actual collisions with other vehicles, which other vehicles may or may not be autonomous and may or may not be occupied.

### BRIEF DESCRIPTION OF THE DRAWINGS

FIG. 1 is a block diagram of an example occupancy-based vehicle collision management system.

FIG. 2 illustrates an example vehicle operation scenario.

FIG. 3 is a flow diagram illustrating an example process for occupancy-based vehicle collision management.

### DETAILED DESCRIPTION

As disclosed herein, a system comprises a host vehicle computer programmed to generate a map identifying one or more surrounding vehicles including respective occupancy statuses for each surrounding vehicle; predict a host vehicle collision event; and, based on the predicted collision event and the occupancy statuses, actuate a host vehicle component.

The computer can be further programmed to receive identifying indicia of one or more vehicles from a remote server, and to identify one or more of the surrounding vehicles according to the identifying indicia. The identifying indicia can include a vehicle license plate.

The occupancy statuses can each include one of occupied, unoccupied, and unknown.

Programming of the host vehicle computer to actuate a host vehicle component can include programming not to actuate the host vehicle component.

The system can comprise a second computer programmed to transmit the occupancy statuses to the host vehicle computer. The host vehicle computer can be further programmed to transmit a host vehicle occupancy status to the second computer.

The system can further comprise a second computer in a second vehicle that is one of the one or more surrounding vehicles, the second computer programmed to transmit a second vehicle occupancy status.

The computer can be further programmed to predict the collision event based on a detected fault in a vehicle brake system.

The computer can be further programmed to actuate the host vehicle component to cause the host vehicle to collide with one of the surrounding vehicles that has an unoccupied occupancy status.

A method comprises generating a map identifying one or more surrounding vehicles including respective occupancy statuses for each surrounding vehicle; predicting a host vehicle collision event; and based on the predicted collision event and the occupancy statuses, actuating a host vehicle component.

The method can further comprise receiving identifying indicia of one or more vehicles from a remote server, and identifying one or more of the surrounding vehicles according to the identifying indicia. The identifying indicia can include a vehicle license plate.

The occupancy statuses can each include one of occupied, unoccupied, and unknown.

The method can further comprise not actuating the host vehicle component upon determining no collision event is predicted.

The occupancy statuses can be received in the host vehicle from a remote computer outside the host vehicle.

The method can further comprise transmitting a host vehicle occupancy status from the host vehicle to the to the remote computer.

The method can further comprise transmitting a second vehicle occupancy status from the second vehicle.

The method can further comprise predicting the collision event based on a detected fault in a vehicle brake system.

The method can further comprise actuating the host vehicle component to cause the host vehicle to collide with one of the surrounding vehicles that has an unoccupied occupancy status.

A computer or computers can be programmed to executed various steps of the method, including a computer or computers in a host vehicle and remote from the host vehicle.

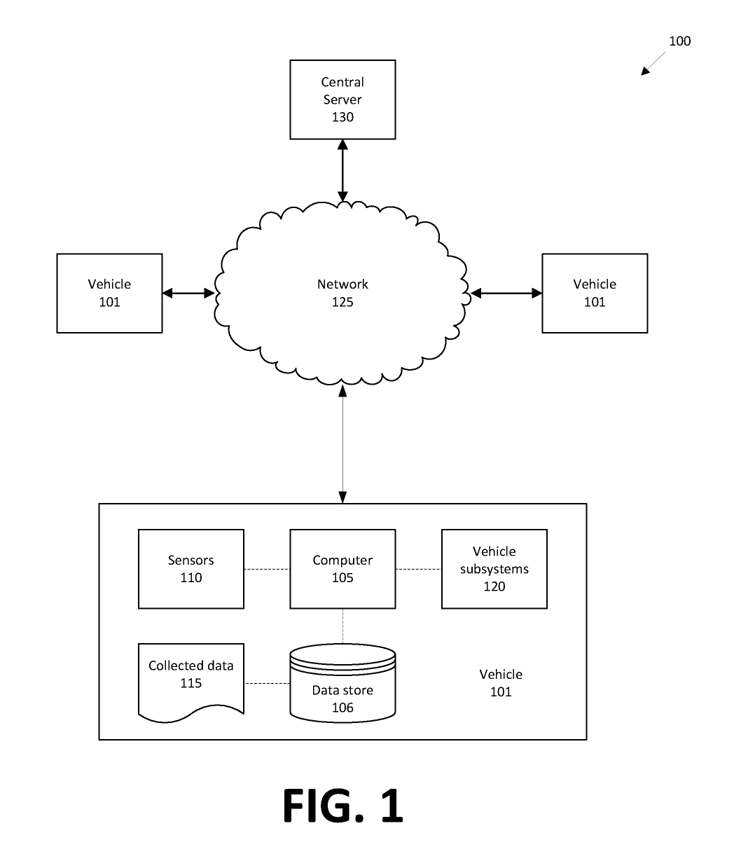

As illustrated in FIG. 1, an occupancy-based vehicle collision management system 100 includes two or more vehicles 101; for ease of illustration three vehicles 101 are shown in FIG. 1. Each of the vehicles 101 includes a computer 105, an associated data store 106, sensors 110 providing collected data 115, as well as various vehicle subsystems 120 that can be controlled by the computer 105 and/or provide data 115 thereto. (For ease of illustration, the elements 105, 106, 110, 115, and 120 are shown with respect to one of the vehicles 101; it is to be understood that like elements may be included in each of the vehicles 101 in the system 100.)

The computer 105 is generally programmed for communications on a vehicle 101 network, e.g., including a communications bus, as is known. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, etc., included in subsystems 120, as well as sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 may be of any known type, e.g., hard disk drives, solid state drives, servers, or any volatile or non-volatile media. The data store 106 may store the collected data 115 sent from the sensors 110.

The computer 105 includes or is connected to a communication interface that can be implemented via circuits, chips, or other electronic components that can facilitate wireless communication with other vehicles or infrastructure devices via, e.g., the Dedicated Short-Range Communication (DSRC) protocol. Via the communication interface 110, the computer 105 may be programmed to wirelessly transmit messages to, and receive messages from, other vehicles 101 and infrastructure devices, e.g., the central server 130. The received messages may be transmitted and/or interpreted to provide instructions for vehicle 101 subsystems 120. Messages including such control signals may be transmitted according to any number of wireless communication protocols, including DSRC.

Sensors 110 may include a variety of devices. For example, as is known, various controllers in a vehicle 101 may operate as sensors 110 to provide data 115 via the vehicle 101 network or bus, e.g., data 115 relating to vehicle speed, acceleration, position, subsystem and/or subsystem status, etc. Further, other sensors 110 could include cameras, motion detectors, etc., i.e., sensors 110 to provide data 115 for evaluating a location of a target, projecting a path of a target, evaluating a location of a roadway lane, etc. The sensors 110 could also include short range radar, long range radar, LIDAR, and/or ultrasonic transducers. Further, the sensors 110 typically include occupancy sensors of one or more types. For example, weight sensors in vehicle seat, cameras, etc., can be used to determine whether the vehicle 101 cabin is occupied by one or more human persons.

Collected data 115 may include a variety of data collected in a vehicle 101. Examples of collected data 115 are provided above, and moreover, data 115 are generally collected using one or more sensors 110, and may additionally include data calculated therefrom in the computer 105, and/or at a central server 130. Collected data 115 may also be provided from vehicle subsystems 120, e.g., an electronic control unit (ECU) in an engine subsystem 120 can provide data relating to engine speed, to provide just one example In general, collected data 115 may include any data that may be gathered by the sensors 110 and/or subsystems 120, and/or computed from such data. In particular, collected data 115 can include data from occupancy sensors, and further data 115 derived therefrom that indicates that the vehicle 101 cabin is one of occupied and not occupied by one or more human persons.

Accordingly, the computer 105 is programmed to receive data 115 indicating vehicle 101 occupancy and/or data from which vehicle 101 occupancy can be determined. Further, the computer 105 is programmed to, upon determining that the vehicle 101 is moving on a roadway or the like, transmit a message, typically via the network 125, to the server 130 specifying that the vehicle 101 is one of occupied and not occupied. The message will further include an identifier for the vehicle 101, e.g., a vehicle identification number (VIN) or other substantially unique identifier. Moreover, a message from a vehicle 101 computer 105 concerning vehicle 101 occupancy may include a description of external indicia on the vehicle 101 from which the vehicle 101 can be identified. For example, it is possible that the external indicia and the substantially unique identifier are the same, e.g., a license plate number and/or state or other jurisdiction of issue. Further, the external indicia could be some other marketing or markings viewable on a vehicle 101 exterior, e.g., a pattern of paint or stickers, an alphanumeric code affixed to the vehicle 101 of other than a license plate, etc. Yet further, the server 130 could store the external indicia for each vehicle 101, to be retrieved upon receipt of a message from a vehicle 101 including a substantially unique identifier, such as a VIN, wherein the VIN is associated with the stored external indicia in a data store of the server 130.

The vehicle 101 may include a plurality of vehicle subsystems 120. As used herein, each vehicle subsystem 120 includes one or more hardware subsystems adapted to perform a mechanical function or operation—such as moving the vehicle, slowing or stopping the vehicle, steering the vehicle, etc. Non-limiting examples of subsystems 120 include a propulsion subsystem 120 (that includes, e.g., an internal combustion engine and/or an electric motor, etc.), a transmission subsystem 120, a steering subsystem 120 (e.g., that may include one or more of a steering wheel, a steering rack, etc.), a brake subsystem 120, a park assist subsystem 120, a movable seat, etc.

When the computer 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator.

The system 100 may further include a network 125 providing communications to and from vehicle 101 computers and one or more central servers 130 (one server 130 being shown in FIG. 1 for ease of illustration). The computer 105 may further be programmed to communicate remote sites, i.e., remote computers such as the server 130, via the network 125. The network 125 represents one or more mechanisms by which a vehicle computer 105 may communicate with a remote server 130. In the context of the present disclosure, “remote” means physically apart from, e.g., that the server 130 is remote from a vehicle 101 means that the server 130 is physically outside of, and spatially separated, typically by a distance measured in kilometers or miles, from the vehicle 101. Thus, if the vehicle 101 computer 105 communicates with another computer that is “remote,” that other computer cannot be in or on the vehicle 101.

Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The central server 130 is a computing device such as is known, i.e., including one or more processors and memories, and possibly embodied as multiple and/or distributed computing devices. The central server 130 can receive messages from one or more vehicles 101, e.g., via the network 125, as noted above. Further, as noted above, the server 130 can store an indication of whether a vehicle 101 is presently occupied or unoccupied, and may also store, in association with the substantially unique identifier for each vehicle 101, data specifying external indicia, e.g., a license plate number and jurisdiction of issue, of a vehicle 101 from which the vehicle 101 can be identified.

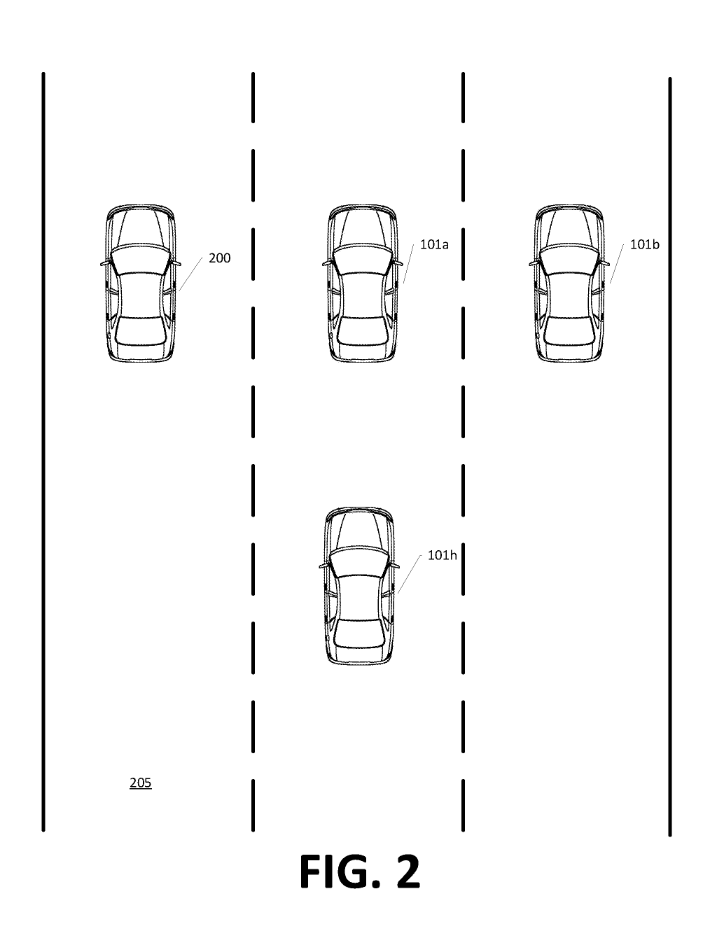

FIG. 2 illustrates an example vehicle 101 operation scenario. A host vehicle 101h travels on a roadway 205. The host vehicle 101h is an autonomous vehicle participating in the system 100 of FIG. 1. The host vehicle 101h is so designated for convenience to indicate that it is the vehicle 101 from whose perspective the collision management techniques described herein are carried out. As noted above, the system 100 typically includes multiple vehicles 101; the example of FIG. 2 shows autonomous vehicles 101a, 101b traveling on the roadway 205 in front of the vehicle 101h. Further, vehicles 101 and the system 100 may share a roadway 205 with one or more vehicles 200 (one such being shown in FIG. 2 for ease of illustration) that are not part of the system 100, i.e., that are not autonomous or semi-autonomous and/or that do not provide information, including occupancy data, to the server 130.

It might be assumed that, in the scenario shown in FIG. 2, that if the host vehicle 101h experienced a brake failure or the like, that the vehicle 101h would collide with the vehicle immediately forward thereof, i.e., the vehicle 101a however, in the context of the system 100, this is only one possible result. For example, the vehicle 101a could have indicated to the server 130 that the vehicle 101a is not occupied. In this case, upon a brake failure or the like in the host vehicle 101h, the host vehicle 101h computer, having been apprised by the server 130 that the vehicle 101a is not occupied, could execute programming to maintain a trajectory under which a front of the vehicle 101h will collide with a rear of the vehicle 101a however, in a case in which the vehicle 101a has reported occupancy to the server 130, but the vehicle 101b has reported non-occupancy to the server 130, the vehicle 101h computer can execute programming to actuate a steering subsystem 120 of the vehicle 101h to cause the vehicle 101h front to collide with a rear of the unoccupied vehicle 101b instead of the occupied vehicle 101a, i.e. Thus, the present system 100 solves a pressing problem in autonomous vehicle collision management, specifically the problem of identifying and selecting a collision course and another vehicle for collision in a manner to minimize risk to humans occupying vehicles on roadways.

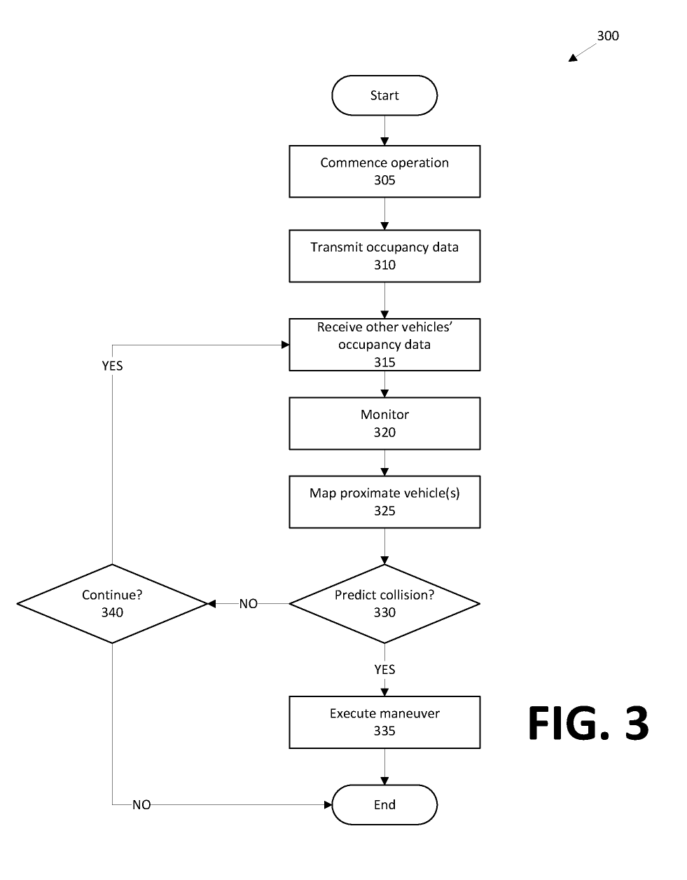

FIG. 3 is a flow diagram illustrating an example process 300 for occupancy-based vehicle collision management. The process 300 may be executed according to programming in one or more vehicle 101 computers 105 and/or servers 130, as described with more particularly below. For example, referring to the example of FIG. 2, certain steps described herein below could be executed as programming in a host vehicle 101h computer 105.

The process 300 begins in a block 305, in which a vehicle 101h, controlled by programming in its computer 105, begins operations, i.e., navigation or movement on a roadway 205 or the like, in an autonomous or semi-autonomous mode in which the computer 105 controls at least vehicle 101h steering.

Upon commencing operation in the block 305, next, in a block 310, the computer 105 determines whether the vehicle 101h is occupied, i.e., whether one or more humans are present in the vehicle 101h cabin. Such determination can be made using occupancy sensors 110, as described above. The computer 105 then transmits its occupancy data, i.e., whether the vehicle 101h is occupied or unoccupied, to the server 130. The transmitted occupancy data typically includes a substantially unique identifier and/or external identifying indicia as described above, as well as a vehicle 101h location, e.g., GPS coordinates or the like.

Next, in a block 315, the vehicle 101 receives from the server 130 occupancy data relating to other vehicles 101a, 101b, etc., in an area around the location of the vehicle 101h. The area around the vehicle 101h could be for vehicles within a predetermined radius around the vehicle 101h, e.g., 500 meters, 1000 meters, etc., and/or for vehicles 101a, 101b, etc., on a segment of a roadway 205, e.g., a same city block, as the host vehicle 101h. Alternatively, the predetermined area around a vehicle 101h could be defined in other ways. The occupancy data relating to the other vehicles 101a, 101b, etc., could include identifying indicia for each of the other vehicles 101, e.g., license plate data as described above, as well as an indication, for each of the other vehicles 101, that the other vehicle 101 is one of occupied and unoccupied.

Next, in a block 320, the computer 105 in the vehicle 101h monitors its environment, i.e., space outside the vehicle 101h within a range detectable by vehicle 101h sensors 110. The computer 105 can use various collected data 115 as is known to detect objects in its environment, including other vehicles 101, 200 traveling on a roadway 205 or the like with the vehicle 101h. For example, a vehicle 101h camera sensor 110 could be used to capture images of other vehicles 101, 200. Image recognition techniques such as are known could be used to then determine vehicle 101, 200 license plate numbers and jurisdictions above issue and/or other identifying indicia for surrounding vehicles 101, 200. The vehicle 101h computer 105 can then determine whether identifying indicia for surrounding vehicles 101, 200 are associated with vehicles 101 for which the server 130 has provided occupancy data.

Following the block 320, in a block 325, the vehicle 101h computer 105 generates a virtual map of surrounding vehicles 101, 200, i.e., vehicles 101 detected and identified as described above with respect to the block 320 and for which the server 130 provided occupancy data as described above with respect to the block 315, as well as vehicles 200 that are not matched to any identifying indicia provided by the server 130. For example, the virtual map could indicate a relative location of one or more surrounding vehicles 101, 200 with respect to the vehicle 101h. In the present context, a virtual map is a set of data specifying a location of a host vehicle 101h with respect to other objects including other vehicles 101, e.g., according to a polar or Cartesian coordinate system or the like in which the host vehicle 101h is at a center of the coordinate system, and locations of other vehicles 101 and possibly other objects such as vehicles 200, etc., are specified according to the coordinate system. Alternatively, a virtual map could specify the location of the host vehicle 101h according to GPS coordinates or the like, and could also specify respective locations of other objects on the virtual map with respect to such coordinates.

The virtual map also includes an occupancy status of each of the indicated vehicles 101, 200. An occupancy status for a vehicle 101, 200 is data indicating that the vehicle 101, 200 is one of “occupied” or “unoccupied” (i.e., “not occupied”), or that the occupancy status is “unknown.” In the case of an unidentified vehicle 200, an occupancy status is deemed “unknown,” and a vehicle 200 with unknown occupancy status can be treated as an occupied vehicle 101. The virtual map data may also include data specifying a speed and/or direction of travel of other vehicles 101, 200, indicated in the map data.

Following the block 325, in a block 330, the computer 105 determines whether a collision event is predicted between the vehicle 101h and one or more vehicles 101, 200 in the virtual map generated in the block 325. A collision event is an event in which the vehicle 101h collides with another vehicle 101, 200. For example, a collision event could be predicted according to a conventional collision prediction system, e.g., a system that predicts the vehicle 101h is traveling at a rate of speed relative to a rate of speed of a proceeding vehicle 101, 200 such that the vehicle 101h is predicted to strike a rear end of the vehicle 101, 200. Alternatively or additionally, a collision event could be predicted based on a detected fault in a vehicle component 120, i.e., according to data received in the computer 105, e.g., via a vehicle 101h communications bus or the like, e.g., from a braking subsystem 120, indicating a fault or failure, e.g., a brake failure such that vehicle 101h brakes are inoperable to stop the vehicle 101h.

If a collision event is not predicted, then the process 300 can proceed to the block 340; if a collision event is predicted, then the process 300 can proceed to a block 335.

In the block 335, the computer 105h actuates one or more vehicle components 120 to execute a maneuver determined at least in part based on the predicted collision event and respective occupancy statuses of one or more surrounding vehicles 101, 200. For example, as described above with respect to FIG. 2, the computer 105 can be programmed to identify a surrounding vehicle 101 that is not occupied (i.e., has an occupancy status of unoccupied), and to maneuver the vehicle 101h to avoid an occupied vehicle 101 and/or unidentified vehicle 200, and to collide with the unoccupied vehicle 101. Further, if the computer 105 cannot execute a maneuver to collide with an unoccupied vehicle 101, e.g., assume that in FIG. 2 the server 130 has indicated that each of the vehicles 101a, 101b is occupied, then the computer 105 may be programmed to execute a maneuver to remain on a present course, in which case actuating one or more vehicle 101h components 120 should be understood to include possibly not taking action not to actuate any vehicle 101h component 120. Following the block 335, the process 300 ends.

In the block 340, which may follow the block 330, the computer 105 determines whether to continue the process 300. For example, a vehicle 101h may be powered off or its trip may be completed, a change in occupancy status may be detected, necessitating re-commencing the process 300, etc. In any case, if the process 300 is to continue, the block 315 is executed next; otherwise, the process 300 ends following the block 340.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105 generally each include instructions executable by one or more computers such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computer 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 500, one or more of the steps could be omitted, or the steps could be executed in a different order than shown in FIG. 5. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a host vehicle computer comprising a processor and a memory, the memory storing instructions such that the computer is programmed to:
generate a map identifying one or more surrounding vehicles including respective occupancy statuses for each surrounding vehicle, each occupancy status being one of occupied, unoccupied, and unknown;
predict a host vehicle collision event; and
based on the predicted collision event and the occupancy statuses, actuate a host vehicle component.

2. The system of claim 1, the computer further programmed to receive identifying indicia of one or more vehicles from a remote server, and to identify one or more of the surrounding vehicles according to the identifying indicia.

3. The system of claim 2, wherein the identifying indicia includes a vehicle license plate.

4. (canceled)

5. The system of claim 1, wherein programming of the host vehicle computer to actuate a host vehicle component includes programming not to actuate the host vehicle component.

6. The system of claim 1, further comprising a second computer programmed to transmit the occupancy statuses to the host vehicle computer.

7. The system of claim 6, the host vehicle computer further programmed to transmit a host vehicle occupancy status to the second computer.

8. The system of claim 1, further comprising a second computer in a second vehicle that is one of the one or more surrounding vehicles, the second computer programmed to transmit a second vehicle occupancy status.

9. The system of claim 1, wherein the computer is further programmed to predict the collision event based on a detected fault in a vehicle brake system.

10. The system of claim 1, wherein the computer is further programmed to actuate the host vehicle component to cause the host vehicle to collide with one of the surrounding vehicles that has an unoccupied occupancy status.

11. A method, comprising:
generating a map identifying one or more surrounding vehicles including respective occupancy statuses for each surrounding vehicle, each occupancy status being one of occupied, unoccupied, and unknown;
predicting a host vehicle collision event; and
based on the predicted collision event and the occupancy statuses, actuating a host vehicle component.

12. The method of claim 11, further comprising receiving identifying indicia of one or more vehicles from a remote server, and identifying one or more of the surrounding vehicles according to the identifying indicia.

13. The method of claim 12, wherein the identifying indicia includes a vehicle license plate.

14. (canceled)

15. The method of claim 11, further comprising not actuating the host vehicle component upon determining no collision event is predicted.

16. The method of claim 11, wherein the occupancy statuses are received in the host vehicle from a remote computer outside the host vehicle.

17. The method of claim 16, further comprising transmitting a host vehicle occupancy status from the host vehicle to the to the remote computer.

18. The method of claim 11, further transmitting a second vehicle occupancy status from the second vehicle.

19. The method of claim 11, further comprising predicting the collision event based on a detected fault in a vehicle brake system.

20. The method of claim 11, further comprising actuating the host vehicle component to cause the host vehicle to collide with one of the surrounding vehicles that has an unoccupied occupancy status.
